(19) United States
(12) Patent Application Publication
(10) Pub. No.: US 2004/0114074 A1
(43) Pub. Date: Jun. 17, 2004

(54) Liquid crystal display device

(75) Inventor: Yuji Yamamoto, Kagoshima (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD TECHNOLOGIES, LTD.

(21) Appl. No.: 10/729,924

(22) Filed: Dec. 9, 2003

(30) Foreign Application Priority Data
Dec. 9, 2002 (JP) 2002-357052

(51) Int. Cl. G02F 1/1335

(52) U.S. Cl. 349/113

(57) ABSTRACT

A first substrate in a liquid crystal display device including the first substrate on which a thin film transistor is fabricated, a second substrate spaced away from and facing the first substrate, and a liquid crystal layer sandwiched between the first and second substrates, wherein an externally incident light is reflected towards a viewer to display images, includes (a) an electrically insulating substrate, (b) a plurality of projections formed on the electrically insulating substrate for scattering reflected light, (c) a first electrically insulating film covering the projections therewith, (d) a light-reflecting film formed on the first electrically insulating film, (e) a second electrically insulating transparent film formed on the light-reflecting film, and (f) a pixel electrode formed on the second electrically insulating transparent film.

### BACKGROUND OF THE INVENTION

1. Field of the Invention

The invention relates to a liquid crystal display device in which an externally incident light is reflected towards a viewer so as to use externally incident light as a light source, and more particularly to a liquid crystal display device having enhanced visibility.

2. Description of the Related Art

A liquid crystal display device is grouped into a light-transmission type one, a light-reflection type one, and a combination type one in accordance with a light source.

A light-transmission type liquid crystal display device is designed to include a backlight source, and display images through backlight emitted from the backlight source.

A light-reflection type liquid crystal display device is designed to include therein a light-reflecting film at which an externally incident light is reflected towards a viewer. Hence, a light-reflection type liquid crystal display device is not necessary to have a backlight source unlike a light-transmission type liquid crystal display device.

A combination type liquid crystal display device is designed to have a first area in which images are displayed through backlight emitted from a back light source and a second area in which image are displayed by reflecting an externally incident light towards a viewer.

A liquid crystal display device, in particular, a liquid crystal display device used in a mobile communication terminal or a cellular phone, can consume only a limited amount of power supplied from a battery. Accordingly, reduction in power consumption in a liquid crystal panel is one of purposes to be accomplished in a liquid crystal display device.

In order to increase efficiency at which backlight is used in a liquid crystal panel in a conventional liquid crystal display device, improvement was made in a light-guide plate or a light-diffusion sheet. As an alternative, a conventional liquid crystal display device was designed to include a wiring layer having a reduced width in a display area for enhancing an aperture ratio.

However, as a volume of data a mobile communication device or a cellular phone deals with significantly increases, a liquid crystal panel is required to display images at high accuracy resulting with much power consumption.

It is now quite difficult to improve respective parts constituting a liquid crystal display device. Hence, there have been suggested a light-reflection type liquid crystal display device in which a light entering therein through a liquid crystal panel is used as a light source with the result of no necessity of a backlight source, and a combination type liquid crystal display device in which backlight is emitted in darkness and which uses a light entering therein through a liquid crystal panel as a light source in brightness.

Light-reflection and combination type liquid crystal display devices as mentioned above are designed to have a light-reflecting plate for reflecting surrounding light towards a viewer, in place of a conventional light-guide plate.

FIG. 1 is a partial cross-sectional view of a conventional combination type liquid crystal display device.

The illustrated liquid crystal display device is comprised of a first substrate on which a thin film transistor is fabricated, a second substrate (not illustrated) spaced away from and facing the first substrate, and a liquid crystal layer (not illustrated) sandwiched between the first and second substrates. An externally incident light is reflected towards a viewer to display images. FIG. 1 is a cross-sectional view of the first substrate 900 in the liquid crystal display device.

As illustrated in FIG. 1, the first substrate 900 is comprised of a glass substrate 901, a gate electrode 902 formed on the glass substrate 901, a gate insulating film 903 formed on the glass substrate 901, covering the gate electrode 902 therewith, a semiconductor layer 904 formed on the gate insulating film 903 above the gate insulating film 902, a signal electrode 905 covering the gate insulating film 903 and a part of the semiconductor layer 904 therewith, and acting as source and drain electrodes, an electrically insulating inorganic film 906 formed on the gate insulating film 903 and a part of the signal electrode 905 in a light-reflection area 900A and a light-transmission area 900B, a plurality of projections 907 formed on the electrically insulating inorganic film 906 in the light-reflection area 900A, an electrically insulating organic film 908 formed on the electrically insulating inorganic film 906 to cover the projections 907 therewith in the light-reflection area 900A, a light-reflection film 909 formed on the electrically insulating organic film 908 in the light-reflection area 900A, and a pixel electrode 910 formed on the electrically insulating inorganic film 906 in the light-transmission area 900B.

In the light-reflection area 900A in which the light-reflection film 909 extends, surrounding light entering the liquid crystal display device is reflected by the light-reflection film 909 towards a viewer. The thus reflected light forms images to a viewer.

In the light-transmission area 900B in which the light-reflection film 909 is not formed, light emitted from a backlight source (not illustrated) located below the glass substrate 901 passes through the first substrate 900, the liquid crystal layer and the second substrate, and reaches a viewer to present images to him/her.

The above-mentioned combination type liquid crystal display device is accompanied with a problem that there occurs phenomenon called “parallax” in which liquid crystal images and displayed images do not overlap each other when a viewer obliquely looks at a surface of a liquid crystal panel, resulting in significant deterioration in visibility.

Since a light-reflection type liquid crystal display device is equal to a combination type liquid crystal display device in having a function of reflecting incident light towards a viewer, a combination type liquid crystal display device is also accompanied with the above-mentioned problem.

Hence, recently the light-reflection film 909 is frequently comprised of an aluminum (Al) film.

However, it is unavoidable for the light-reflection film 909 comprised of an aluminum (Al) film to be accompanied with problems that the light-reflection film 909 is corroded in moisture environment, and that an indium-tin oxide (ITO) film of which a transparent electrode is comprised is removed because of oxidation-reduction reaction between the light-reflection film 909 and the ITO film. The problems significantly deteriorate a fabrication yield and reliability in a process of fabricating a thin film transistor.

In order to solve the problems, there has been suggested a light-reflection film comprised of a silver (Ag) film. However, a silver film is not practical with respect to fabrication cost.

Thus, Japanese Patent Application Publication No. 2000-162625 has suggested a light-reflection type liquid crystal display device having CF on TFT (Color Filter on Thin Film Transistor) structure in which an aluminum film is covered with a color filter layer.

However, in the suggested liquid crystal display device, a light-reflection film composed of aluminum and a pixel electrode composed of ITO make contact with each other, and hence, the above-mentioned problems remain unsolved.

Japanese Patent Application Publication No. 2001-209043 has suggested a light-reflection type liquid crystal display device including an upper transparent substrate on which a thin film active device is not fabricated, but a transparent electrode pattern is formed, a lower substrate on which a thin film active device is not fabricated, but a transparent electrode pattern is formed, and a liquid crystal layer sandwiched between the upper and lower substrates. On the lower substrate are formed a wavy layer, a light-reflection layer, a protection layer, a planarizing layer, and a transparent electrode.

Japanese Patent Application Publication No. 2001-249358 has suggested a liquid crystal display device in which liquid crystal sandwiched between two substrates is driven through a pixel electrode. The liquid crystal display device includes an active device array substrate having a first film covering a channel area of an active device therewith and cooperating with an electrically insulating film located thereabove to define a first wavy area and a first contact hole, a second film having a second wavy area and a second contact hole located the first wavy area and the first contact hole, respectively, and a pixel electrode formed on the second wavy area and electrically connected to an electrode of the active device through the second contact hole.

### SUMMARY OF THE INVENTION

In view of the above-mentioned problems in the conventional liquid crystal display devices, it is an object of the present invention to provide a light-reflection type or a combination type liquid crystal display device which is capable of preventing a light-reflection film composed of aluminum and a pixel electrode composed of ITO from making contact with each other, and accordingly, enhancing a fabrication yield, reliability and visibility.

In one aspect of the present invention, there is provided a first substrate in a liquid crystal display device including the first substrate on which a thin film transistor is fabricated, a second substrate spaced away from and facing the first substrate, and a liquid crystal layer sandwiched between the first and second substrates, wherein an externally incident light is reflected towards a viewer to display images, the first substrate including (a) an electrically insulating substrate, (b) a plurality of projections formed on the electrically insulating substrate for scattering reflected light, (c) a first electrically insulating film covering the projections therewith, (d) a light-reflecting film formed on the first electrically insulating film, (e) a second electrically insulating transparent film formed on the light-reflecting film, and (f) a pixel electrode formed on the second electrically insulating transparent film.

For instance, the second electrically insulating transparent film may be comprised of an organic film or an inorganic film.

The light-reflecting film may be designed to cover at least a part of a display pixel area of the thin film transistor therewith. That is, the present invention may be applied to a light-transmission type and a combination type liquid crystal display device.

There is further provided a first substrate in a liquid crystal display device including the first substrate on which a thin film transistor is fabricated, a second substrate spaced away from and facing the first substrate, and a liquid crystal layer sandwiched between the first and second substrates, wherein an externally incident light is reflected towards a viewer to display images, the first substrate including (a) an electrically insulating substrate, (b) a plurality of projections formed on the electrically insulating substrate for scattering reflected light, (c) a first electrically insulating film covering the projections therewith, (d) a light-reflecting film formed on the first electrically insulating film, (e) a color layer formed on the light-reflecting film, and (fi) a pixel electrode formed on the color layer.

The first substrate may further include a second electrically insulating transparent film formed on the color layer.

In another aspect of the present invention, there is provided a liquid crystal display device including a first substrate on which a thin film transistor is fabricated, a second substrate spaced away from and facing the first substrate, and a liquid crystal layer sandwiched between the first and second substrates, wherein an externally incident light is reflected towards a viewer to display images, the first substrate including (a) an electrically insulating substrate, (b) a plurality of projections formed on the electrically insulating substrate for scattering reflected light, (c) a first electrically insulating film covering the projections therewith, (d) a light-reflecting film formed on the first electrically insulating film, (e) a second electrically insulating transparent film formed on the light-reflecting film, and (f) a pixel electrode formed on the second electrically insulating transparent film.

For instance, the second electrically insulating transparent film may be comprised of an organic film or an inorganic film.

The light-reflecting film may be designed to cover at least a part of a display pixel area of the thin film transistor therewith. That is, the present invention may be applied to a light-transmission type and a combination type liquid crystal display device.

There is further provided a liquid crystal display device including a first substrate on which a thin film transistor is fabricated, a second substrate spaced away from and facing the first substrate, and a liquid crystal layer sandwiched between the first and second substrates, wherein an externally incident light is reflected towards a viewer to display images, the first substrate including (a) an electrically insulating substrate, (b) a plurality of projections formed on the electrically insulating substrate for scattering reflected light, (c) a first electrically insulating film covering the projections therewith, (d) a light-reflecting film formed on the first electrically insulating film, (e) a color layer formed on the light-reflecting film, and (f) a pixel electrode formed on the color layer.

In the above-mentioned liquid crystal display device, the first substrate may further include a second electrically insulating transparent film formed on the color layer.

The advantages obtained by the aforementioned present invention will be described hereinbelow.

In accordance with the present invention, in a light-reflection or combination type liquid crystal display device in which a light-reflection film is formed partially or wholly in a pixel area, the second electrically insulating film or the color layer as an interlayer insulating film is formed partially on a thin film transistor including a gate wiring and a signal wiring or entirely on a display area, after a light-reflection film has been formed to overlap the gate wiring and the signal wiring, and then, a pixel electrode is formed entirely in a pixel area, overlapping the gate wiring and the signal wiring.

The second electrically insulating film as an interlayer insulating film entirely covers a light-reflection film composed of aluminum therewith to thereby protect the light-reflection film from subsequent chemical steps and electrochemical reaction which will occur in subsequent steps. Hence, it is possible to prevent an indium-tin oxide (ITO) film from being removed due to oxidation-reduction reaction which occurs when indium-tin oxide of which a pixel electrode is composed is developed.

In addition, since aluminum of which a light-reflection film is composed does not make contact with moisture, it is possible to prevent the light-reflection film from being corroded.

Furthermore, it is no longer necessary for the liquid crystal display device to include a metal film called a barrier metal, used for preventing an aluminum film from being corroded in a conventional liquid crystal display device.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a cross-sectional view of an active matrix substrate in a conventional combination type liquid crystal display device.

FIG. 2 is a perspective view of a combination type liquid crystal display device in accordance with the first embodiment of the present invention.

FIG. 3 is a cross-sectional view taken along the line III-III in FIG. 2.

FIG. 4 is a cross-sectional view of an active matrix substrate in the combination type liquid crystal display device illustrated in FIG. 2.

FIG. 5 is a cross-sectional view of a variant of the active matrix substrate illustrated in FIG. 4.

FIG. 6 is a cross-sectional view of an active matrix substrate in a combination type liquid crystal display device in accordance with the second embodiment of the present invention.

FIG. 7 is a cross-sectional view of an active matrix substrate in a combination type liquid crystal display device in accordance with the third embodiment of the present invention.

FIG. 8 is a cross-sectional view of a variant of the active matrix substrate illustrated in FIG. 7.

FIG. 9A is a cross-sectional view of a structure located above a gate wiring in the combination type liquid crystal display device in accordance with the first embodiment.

FIG. 9B is a cross-sectional view of a structure located above a signal wiring in the combination type liquid crystal display device in accordance with the first embodiment.

FIG. 10A is a cross-sectional view of a structure located above a gate wiring in the combination type liquid crystal display device in accordance with the second embodiment.

FIG. 10B is a cross-sectional view of a structure located above a signal wiring in the combination type liquid crystal display device in accordance with the second embodiment.

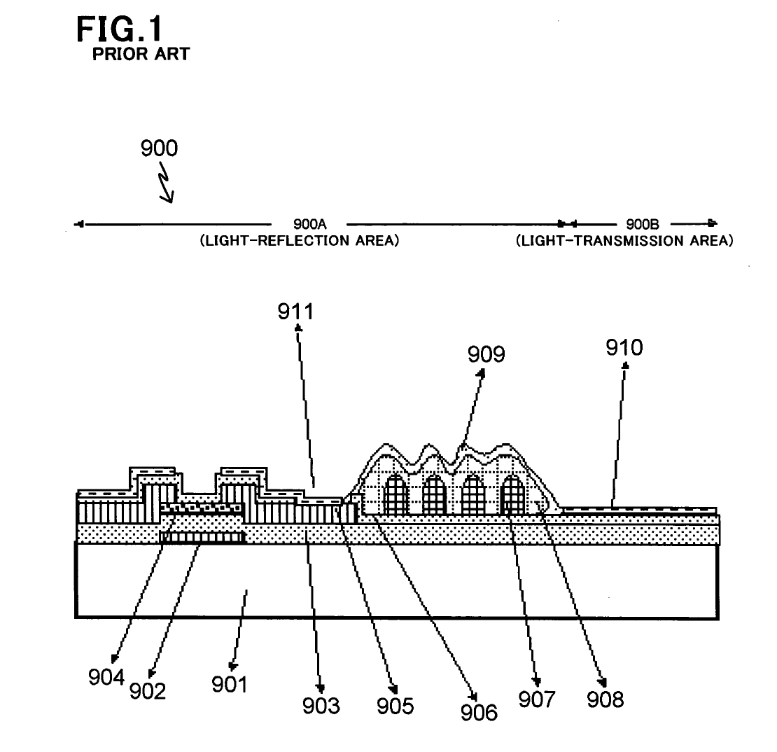

### DESCRIPTION OF THE PREFERRED EMBODIMENTS

Preferred embodiments in accordance with the present invention will be explained hereinbelow with reference to drawings.

[First Embodiment]

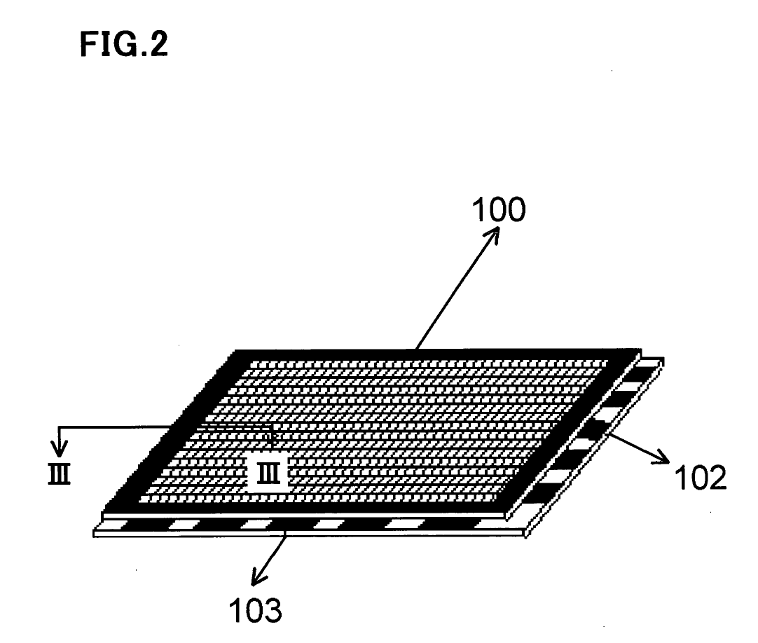

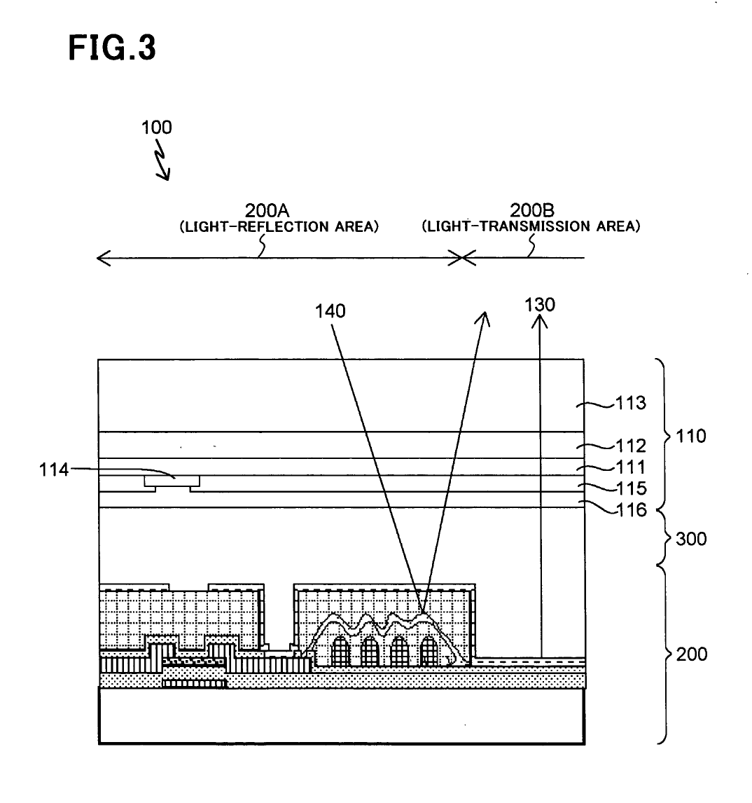

FIG. 2 is a perspective view of a combination type liquid crystal display device 100 in accordance with the first embodiment of the present invention, and FIG. 3 is a cross-sectional view taken along the line III-III in FIG. 2.

As illustrated in FIG. 3, the liquid crystal display device 100 is comprised of an active matrix substrate 200 on which a thin film transistor is fabricated, an opposed substrate 110 spaced away from and facing the active matrix substrate 200, and a liquid crystal layer 300 sandwiched between the active matrix substrate 200 and the opposed substrate 110.

The opposed substrate 110 is comprised of a transparent substrate 111, a retardation plate 112 formed on the transparent substrate 111, a polarizer plate 113 formed on the retardation plate 112, a black matrix layer 114 formed on the transparent substrate 111 so as to face the liquid crystal layer 300, a color layer 115 formed on the transparent substrate 111 so as not to overlap the black matrix layer 114, and an overcoat layer 116 formed covering the black matrix layer 114 and the color layer 115 therewith.

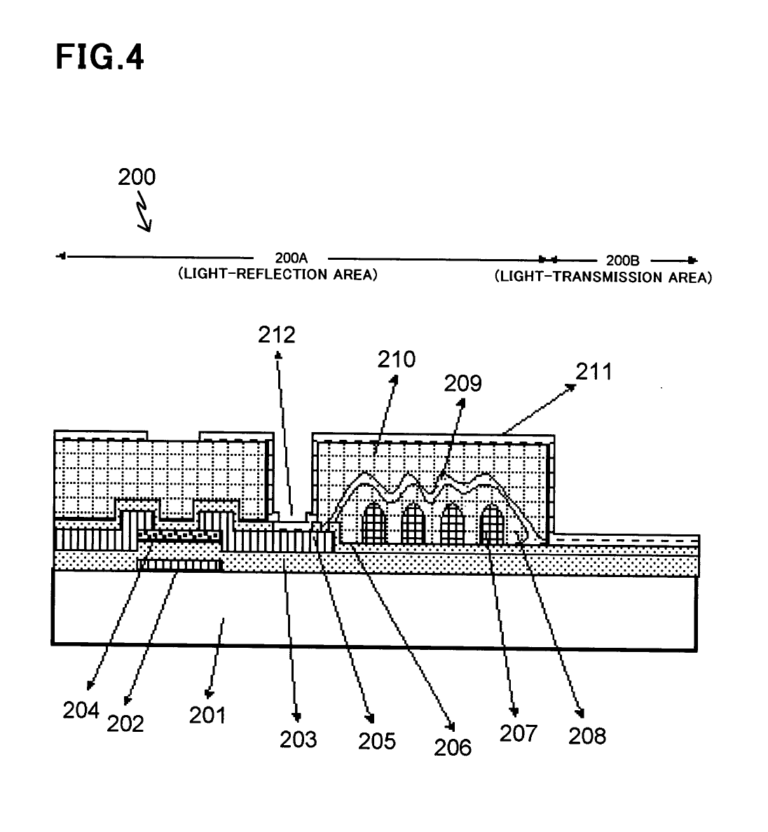

FIG. 4 is an enlarged cross-sectional view of the active matrix substrate 200.

As illustrated in FIG. 4, the active matrix substrate 200 is comprised of a glass substrate 201, a gate electrode 202 formed on the glass substrate 201, a gate insulating film 203 formed on the glass substrate 201, covering the gate electrode 202 therewith, a semiconductor layer 204 formed on the gate insulating film 203 above the gate insulating film 202, a signal electrode 205 covering the gate insulating film 203 and a part of the semiconductor layer 204 therewith, and acting as source and drain electrodes, a first electrically insulating inorganic film 206 formed on the gate insulating film 203 and a part of the signal electrode 205 in a light-reflection area 200A and a light-transmission area 200B, a plurality of projections 207 formed on the first electrically insulating inorganic film 206 in the light-reflection area 200A, a first electrically insulating organic film 208 formed on the electrically insulating inorganic film 206 to cover the projections 207 therewith in the light-reflection area 200A, a light-reflection film 209 formed on the first electrically insulating organic film 208 in the light-reflection area 200A, a second electrically insulating organic film 210 covering therewith the light-reflection film 209 and the first electrically insulating inorganic film 206 formed on the signal electrode 205, and a pixel electrode 211 composed of indium-tin oxide (ITO) and covering therewith a surface of the second electrically insulating organic film 210 which surface includes an inner surface of a contact hole 212 formed throughout the second electrically insulating organic film 210.

The gate electrode 202 extends over a plurality of thin film transistors through a gate wiring 102 illustrated in FIG. 2. Similarly, the signal electrode 205 extends over a plurality of thin film transistors through a signal wiring 103 illustrated in FIG. 3.

The light-reflection film 209 is composed of aluminum providing high light-reflection, and the first electrically insulating inorganic film 206 is composed of silicon nitride SiNx.

The second electrically insulating organic film 210 is a transparent film, and is planarized at a surface thereof. For instance, the second electrically insulating organic film 210 is composed of photosensitive acrylic resin.

The active matrix substrate 200 is comprised further of a retardation plate (not illustrated) formed on the glass substrate 201 at the opposite side of the liquid crystal layer 300, a polarizer plate (not illustrated) formed on the retardation plate, and a backlight source arranged below the polarizer plate.

As illustrated in FIGS. 3 and 4, the active matrix substrate 200 has a light-reflection area 200A in which an externally incident light is reflected towards a viewer, and a light-transmission area 200B in which a light emitted from a backlight source passes through the active matrix substrate 200, the liquid crystal layer 300, and the opposed substrate 110.

In the light-transmission area 200B, on the glass substrate 201 is formed only the pixel electrode 211 composed of a transparent material, specifically, indium-tin oxide (ITO). Hence, a light 130 (see FIG. 3) emitted from a backlight source passes through the transparent pixel electrode 211, the liquid crystal layer 300, and the opposed substrate 110 in the light-transmission area 200B, and reaches a viewer. Thus, certain image is displayed on a liquid crystal panel.

In the light-reflection area 200A, the light-reflection film 209 having a wavy surface is formed above the glass substrate 201.

Hence, an externally incident light 140 (see FIG. 3) is reflected at the light-reflection film 209, passes through the transparent pixel electrode 211, the liquid crystal layer 300, and the opposed substrate 110, and reaches a viewer, similarly to the light 130. Thus, certain image is displayed on a liquid crystal panel.

The retardation plate (not illustrated) provides a phase difference of a quarter of a wavelength to the lights 130 and 140. Passing through the polarizer plate (not illustrated), circularly polarized light is converted into linearly polarized light and vice versa in the lights 130 and 140.

The projections 207 formed for efficiently reflecting incident light is comprised of an organic film. The first electrically insulating organic film 208 is formed as an interlayer insulating film for spacing the projections 207 away from one another.

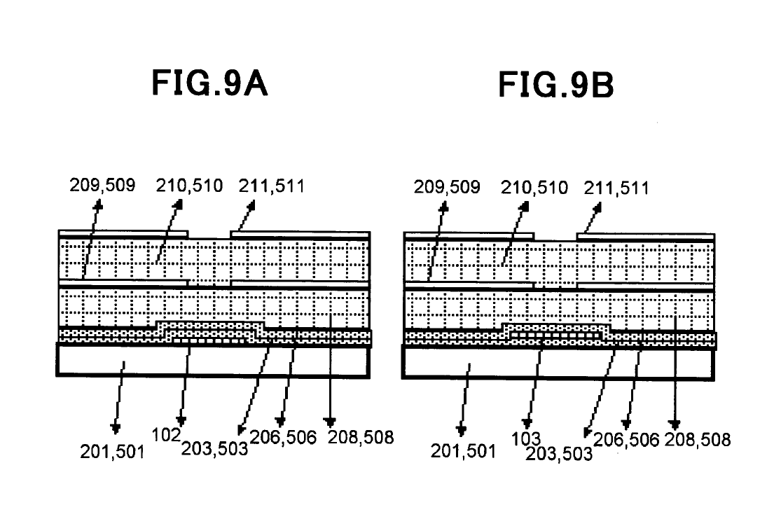

FIG. 9A is a cross-sectional view of a structure located above a gate wiring, and FIG. 9B is a cross-sectional view of a structure located above a signal wiring. As illustrated in FIGS. 9A and 9B, the first electrically insulating organic film 208 is formed above the gate wiring and the signal wiring and partially in a pixel.

The light-reflection film 209 is patterned on the first electrically insulating organic film 208 so as to be separated on the gate wiring and the signal wiring.

The combination type liquid crystal display device in accordance with the first embodiment is not necessary to have a metal film called barrier metal, such as a chromium (Cr) film or a molybdenum (Mo) film, used for preventing corrosion of an aluminum film in a conventional liquid crystal display device.

The second electrically insulating organic film 210 is formed above the gate wiring and the signal wiring and partially in a pixel by photolithography, for instance.

The pixel electrode 211 is patterned on the second electrically insulating organic film 210 so as to be separated on the gate wiring and the signal wiring across the contact hole 212.

In the first embodiment, the light-reflection area 200A is formed higher than the light-transmission area 200B. As an alternative, the light-reflection area 200A may be formed equal in height to the light-transmission area 200B.

In accordance with the combination type liquid crystal display device 100, the light-reflection film 209 is entirely covered with the second electrically insulating organic transparent film 210, ensuring that ITO of which the pixel electrode 211 is composed is prevented from being removed due to oxidation-reduction reaction which occurs when ITO is developed.

In addition, since aluminum of which the light-reflection film 209 is composed does not make contact with moisture, it is possible to prevent the light-reflection film 209 from being corroded.

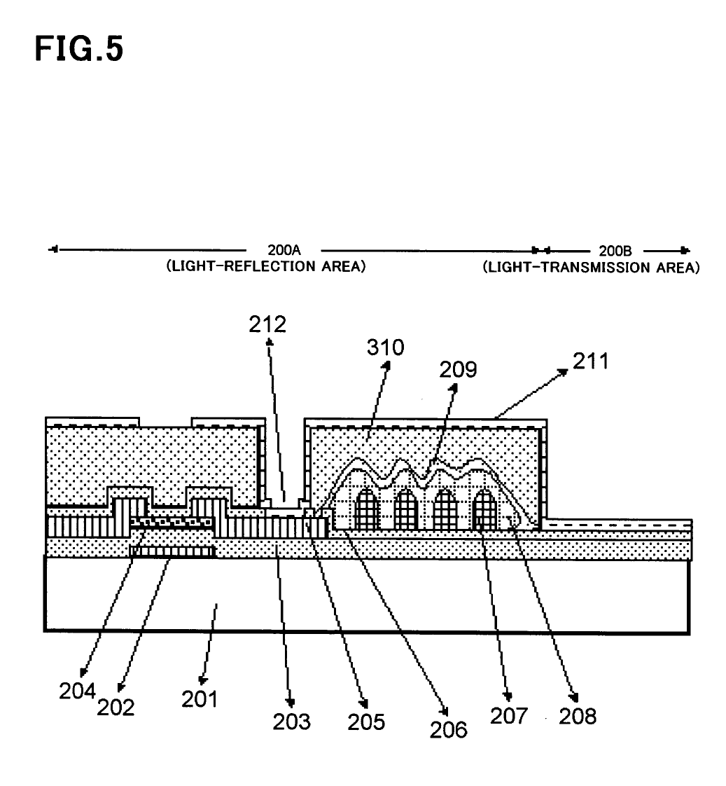

A film used as the second electrically insulating organic film 210 is not always necessary to be an organic film, if it is a transparent film. As illustrated in FIG. 5, the combination type liquid crystal display device 100 may include a second electrically insulating inorganic transparent film 310 in place of the second electrically insulating organic film 210.

[Second Embodiment]

In the combination type liquid crystal display device 100 in accordance with the above-mentioned first embodiment, the opposed substrate 110 includes the color filter layer 115. The present invention may be applied to a combination type liquid crystal display device in which the active matrix substrate 200 has a CF on TFT structure, as explained below as the second embodiment.

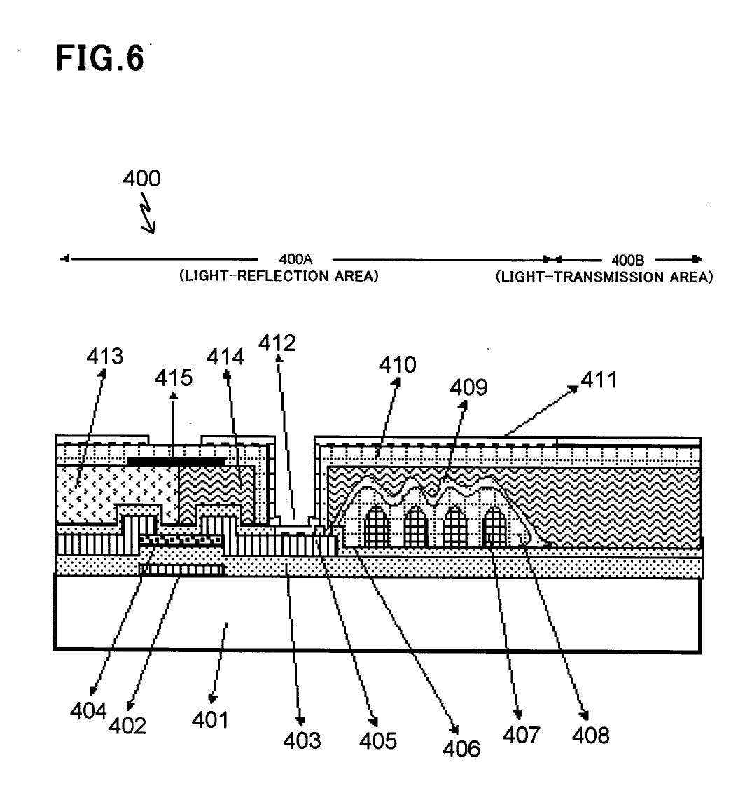

FIG. 6 is a cross-sectional view of an active matrix substrate 400 in a combination type liquid crystal display device in accordance with the second embodiment.

The active matrix substrate 400 is comprised of a glass substrate 401, a gate electrode 402 formed on the glass substrate 401, a gate insulating film 403 formed on the glass substrate 401, covering the gate electrode 402 therewith, a semiconductor layer 404 formed on the gate insulating film 403 above the gate insulating film 402, a signal electrode 405 covering the gate insulating film 403 and a part of the semiconductor layer 404 therewith, and acting as source and drain electrodes, a first electrically insulating inorganic film 406 formed on the gate insulating film 403 and a part of the signal electrode 405 in a light-reflection area 400A and a light-transmission area 400B, a plurality of projections 407 formed on the first electrically insulating inorganic film 406 in the light-reflection area 400A, a first electrically insulating organic film 408 formed on the electrically insulating inorganic film 406 to cover the projections 407 therewith in the light-reflection area 400A, a light-reflection film 409 formed on the first electrically insulating organic film 408 in the light-reflection area 400A, color layers 413 and 414 formed as a color filter, covering the light-reflection film 409 and the first electrically insulating inorganic film 406, a black matrix layer 415 formed on the color layers 413 and 414 above the semiconductor layer 404, a second electrically insulating organic film 410 covering the black matrix layer 415, the color layers 413 and 414, and an inner surface of a contact hole 412 formed throughout the color layer 414, and a pixel electrode 411 composed of indium-tin oxide (ITO) and covering the second electrically insulating organic film 410 therewith.

The gate electrode 402 extends over a plurality of thin film transistors through a gate wiring 102 illustrated in FIG. 2. Similarly, the signal electrode 405 extends over a plurality of thin film transistors through a signal wiring 103 illustrated in FIG. 3.

The color layer 413 is used for emitting a red light, and the color layer 414 is used for emitting a green light.

The light-reflection film 409 is composed of aluminum providing high light-reflection, and the first electrically insulating inorganic film 406 is composed of silicon nitride SiNx.

The second electrically insulating organic film 410 is a transparent film, and is planarized at a surface thereof. For instance, the second electrically insulating organic film 410 is composed of photosensitive acrylic resin.

The active matrix substrate 400 is comprised further of a retardation plate (not illustrated) formed on the glass substrate 401 at the opposite side of the liquid crystal layer 300, a polarizer plate (not illustrated) formed on the retardation plate, and a backlight source arranged below the polarizer plate.

As illustrated in FIG. 6, the active matrix substrate 400 has a light-reflection area 400A in which an externally incident light is reflected towards a viewer, and a light-transmission area 400B in which a light emitted from a backlight source passes through the active matrix substrate 400, the liquid crystal layer 300, and the opposed substrate 110.

In the light-transmission area 400B, on the glass substrate 401 is formed only the pixel electrode 411 composed of a transparent material, specifically, indium-tin oxide (ITO). Hence, a light 130 (see FIG. 3) emitted from a backlight source passes through the transparent pixel electrode 411, the liquid crystal layer 300, and the opposed substrate 110 in the light-transmission area 400B, and reaches a viewer. Thus, certain image is displayed on a liquid crystal panel.

In the light-reflection area 400A, the light-reflection film 409 having a wavy surface is formed above the glass substrate 401.

Hence, an externally incident light 140 (see FIG. 3) is reflected at the light-reflection film 409, passes through the transparent pixel electrode 411, the liquid crystal layer 300, and the opposed substrate 110, and reaches a viewer, similarly to the light 130. Thus, certain image is displayed on a liquid crystal panel.

The retardation plate (not illustrated) provides a phase difference of a quarter of a wavelength to the lights 130 and 140. Passing through the polarizer plate (not illustrated), circularly polarized light is converted into linearly polarized light and vice versa in the lights 130 and 140.

The projections 407 formed for efficiently reflecting incident light is comprised of an organic film. The first electrically insulating organic film 408 is formed as an interlayer insulating film for spacing the projections 407 away from one another.

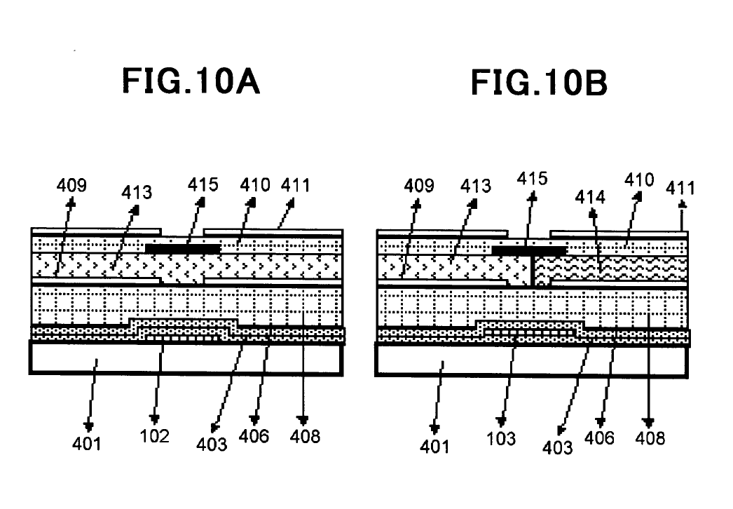

FIG. 10A is a cross-sectional view of a structure located above a gate wiring, and FIG. 10B is a cross-sectional view of a structure located above a signal wiring. As illustrated in FIGS. 10A and 10B, the first electrically insulating organic film 408 is formed above the gate wiring and the signal wiring and partially in a pixel.

The light-reflection film 409 is patterned on the first electrically insulating organic film 408 so as to be separated on the gate wiring and the signal wiring.

The combination type liquid crystal display device in accordance with the second embodiment is not necessary to have a metal film called barrier metal, such as a chromium (Cr) film or a molybdenum (Mo) film, used for preventing corrosion of an aluminum film in a conventional liquid crystal display device.

The second electrically insulating organic film 410 is formed above the gate wiring and the signal wiring and partially in a pixel by photolithography, for instance.

The pixel electrode 411 is patterned on the second electrically insulating organic film 410 so as to be separated on the gate wiring and the signal wiring across the contact hole 412.

In accordance with the combination type liquid crystal display device 400, the light-reflection film 409 is entirely covered with the color layers 413 and 414 or the second electrically insulating organic transparent film 410, ensuring that ITO of which the pixel electrode 411 is composed is prevented from being removed due to oxidation-reduction reaction which occurs when ITO is developed.

In addition, since aluminum of which the light-reflection film 409 is composed does not make contact with moisture, it is possible to prevent the light-reflection film 409 from being corroded.

Since the active matrix substrate 400 is designed to include the color layers 413 and 414 acting as a color filter, on the opposed substrate 110 is formed only a transparent common electrode (not illustrated). Accordingly, a material of which the transparent substrate 111 is composed is not to be limited to glass. For instance, the transparent substrate 111 may be composed of plastic such as polycarbonate or polyethersulfone. As a result, the combination type liquid crystal display device 400 may be fabricated thinner and lighter than a conventional combination type liquid crystal display device which was difficult to be fabricated thinner and lighter, because it included a glass substrate.

A film used as the second electrically insulating organic film 410 is not always necessary to be an organic film, if it is a transparent film. The combination type liquid crystal display device 400 may include an electrically insulating inorganic transparent film in place of the second electrically insulating organic film 410.

It is not always necessary for the combination type liquid crystal display device 400 to include the second electrically insulating organic film 410. The combination type liquid crystal display device 400 may omit the second electrically insulating organic film 410, in which case, the pixel electrode 411 is formed directly on the color layers 413 and 414.

[Third Embodiment]

In the above-mentioned first and second embodiments, the present invention is applied to a combination type liquid crystal display device. In the third embodiment, the present invention is applied to a light-reflection type liquid crystal display device.

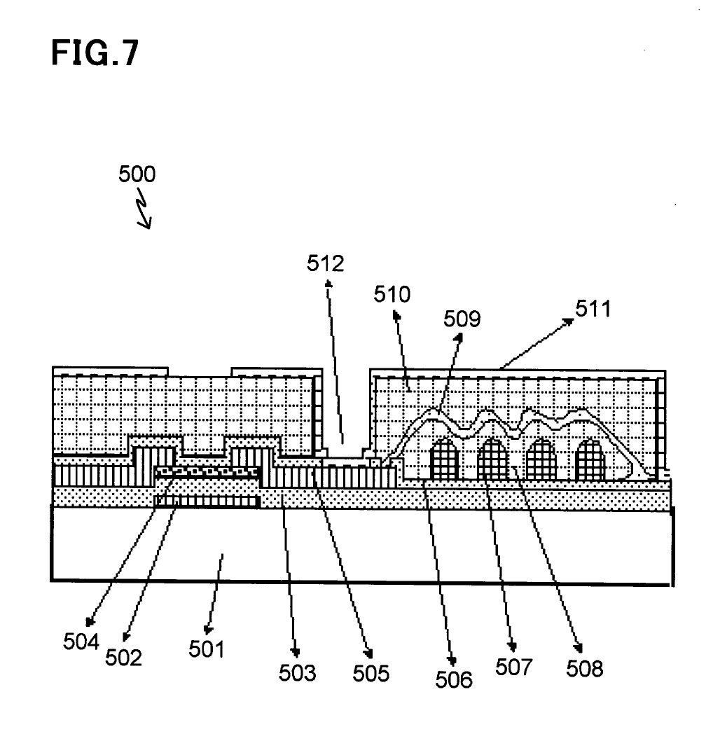

FIG. 7 is a cross-sectional view of an active matrix substrate 500 in the light-reflection type liquid crystal display device in accordance with the third embodiment.

As illustrated in FIG. 7, the active matrix substrate 500 is comprised of a glass substrate 501, a gate electrode 502 formed on the glass substrate 501, a gate insulating film 503 formed on the glass substrate 501, covering the gate electrode 502 therewith, a semiconductor layer 504 formed on the gate insulating film 503 above the gate insulating film 502, a signal electrode 505 covering the gate insulating film 503 and a part of the semiconductor layer 504 therewith, and acting as source and drain electrodes, a first electrically insulating inorganic film 506 formed on the gate insulating film 503 and a part of the signal electrode 505, a plurality of projections 507 formed on the first electrically insulating inorganic film 506, a first electrically insulating organic film 508 formed on the electrically insulating inorganic film 506 to cover the projections 507 therewith, a light-reflection film 509 formed on the first electrically insulating organic film 508, a second electrically insulating organic film 510 covering therewith the light-reflection film 509 and the first electrically insulating inorganic film 506 formed on the signal electrode 505, and a pixel electrode 511 composed of indium-tin oxide (ITO) and covering therewith a surface of the second electrically insulating organic film 510 which surface includes an inner surface of a contact hole 512 formed throughout the second electrically insulating organic film 510.

The gate electrode 502 extends over a plurality of thin film transistors through a gate wiring 102 illustrated in FIG. 2. Similarly, the signal electrode 505 extends over a plurality of thin film transistors through a signal wiring 103 illustrated in FIG. 3.

The light-reflection film 509 is composed of aluminum providing high light-reflection, and the first electrically insulating inorganic film 506 is composed of silicon nitride SiNx.

The second electrically insulating organic film 510 is a transparent film, and is planarized at a surface thereof. For instance, the second electrically insulating organic film 510 is composed of photosensitive acrylic resin.

The active matrix substrate 500 is comprised further of a retardation plate (not illustrated) formed on the glass substrate 501 at the opposite side of the liquid crystal layer 300, a polarizer plate (not illustrated) formed on the retardation plate, and a backlight source arranged below the polarizer plate.

Unlike the combination type liquid crystal display devices 200 and 400 in accordance with the first and second embodiments, the light-reflection type liquid crystal display device 500 in accordance with the third embodiment does not include a light-transmission area in which a light passes therethrough, but includes only a light-reflection area in which a light is reflected towards a viewer.

Hence, an externally incident light 140 (see FIG. 3) is reflected at the light-reflection film 509 having a wavy surface, passes through the transparent pixel electrode 511, the liquid crystal layer 300, and the opposed substrate 110, and reaches a viewer. Thus, certain image is displayed on a liquid crystal panel.

The retardation plate (not illustrated) provides a phase difference of a quarter of a wavelength to the lights 130 and 140. Passing through the polarizer plate (not illustrated), circularly polarized light is converted into linearly polarized light and vice versa in the lights 130 and 140.

The projections 507 formed for efficiently reflecting incident light is comprised of an organic film. The first electrically insulating organic film 508 is formed as an interlayer insulating film for spacing the projections 507 away from one another.

As illustrated in FIGS. 9A and 9B, the first electrically insulating organic film 508 is formed above the gate wiring and the signal wiring and partially in a pixel.

The light-reflection film 509 is patterned on the first electrically insulating organic film 508 so as to be separated on the gate wiring and the signal wiring.

The light-reflection type liquid crystal display device 500 is not necessary to have a metal film called barrier metal, such as a chromium (Cr) film or a molybdenum (Mo) film, used for preventing corrosion of an aluminum film in a conventional liquid crystal display device.

The second electrically insulating organic film 510 is formed above the gate wiring and the signal wiring and partially in a pixel by photolithography, for instance.

The pixel electrode 511 is patterned on the second electrically insulating organic film 510 so as to be separated on the gate wiring and the signal wiring across the contact hole 512.

In accordance with the combination type liquid crystal display device 500, the light-reflection film 509 is entirely covered with the second electrically insulating organic transparent film 510, ensuring that ITO of which the pixel electrode 511 is composed is prevented from being removed due to oxidation-reduction reaction which occurs when ITO is developed.

In addition, since aluminum of which the light-reflection film 509 is composed does not make contact with moisture, it is possible to prevent the light-reflection film 509 from being corroded.

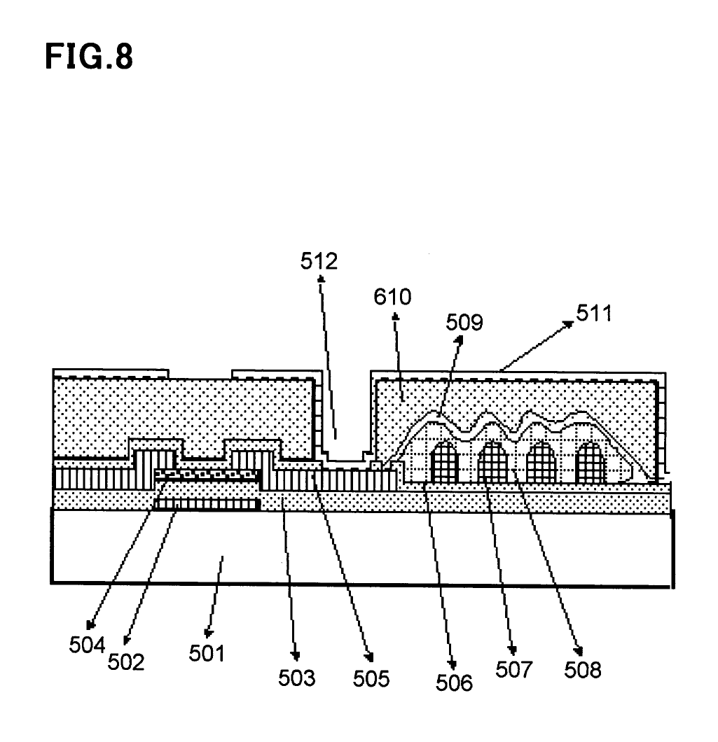

A film used as the second electrically insulating organic film 510 is not always necessary to be an organic film, if it is a transparent film. As illustrated in FIG. 8, the combination type liquid crystal display device 500 may include a second electrically insulating inorganic transparent film 610 in place of the second electrically insulating organic film 510.

The combination type liquid crystal display device in accordance with the third embodiment may be designed t have a “CF on TFT” structure in which a color layer acting as a color filter is formed on the active matrix substrate 500, similarly to the second embodiment.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2002-357052 filed on Dec. 9, 2002 including specification, claims, drawings and summary is incorporated herein by reference in its entirety.

What is claimed is:

1. A first substrate in a liquid crystal display device including said first substrate on which a thin film transistor is fabricated, a second substrate spaced away from and facing said first substrate, and a liquid crystal layer sandwiched between said first and second substrates, wherein an externally incident light is reflected towards a viewer to display images,
said first substrate including:
(a) an electrically insulating substrate;
(b) a plurality of projections formed on said electrically insulating substrate for scattering reflected light;
(c) a first electrically insulating film covering said projections therewith;
(d) a light-reflecting film formed on said first electrically insulating film;
(e) a second electrically insulating transparent film formed on said light-reflecting film; and
(f) a pixel electrode formed on said second electrically insulating transparent film.

2. The first substrate as set forth in claim 1, wherein said second electrically insulating transparent film is comprised of an organic film.

3. The first substrate as set forth in claim 1, wherein said second electrically insulating transparent film is comprised of an inorganic film.

4. The first substrate as set forth in claim 1, wherein said light-reflecting film covers at least a part of a display pixel area of said thin film transistor therewith.

5. A first substrate in a liquid crystal display device including said first substrate on which a thin film transistor is fabricated, a second substrate spaced away from and facing said first substrate, and a liquid crystal layer sandwiched between said first and second substrates, wherein an externally incident light is reflected towards a viewer to display images,
said first substrate including:
(a) an electrically insulating substrate;
(b) a plurality of projections formed on said electrically insulating substrate for scattering reflected light;
(c) a first electrically insulating film covering said projections therewith;
(d) a light-reflecting film formed on said first electrically insulating film;
(e) a color layer formed on said light-reflecting film; and
(f) a pixel electrode formed on said color layer.

6. The first substrate as set forth in claim 5, further comprising a second electrically insulating transparent film formed on said color layer.

7. The first substrate as set forth in claim 6, wherein said second electrically insulating transparent film is comprised of an organic film.

8. The first substrate as set forth in claim 6, wherein said second electrically insulating transparent film is comprised of an inorganic film.

9. The first substrate as set forth in claim 5, wherein said light-reflecting film covers at least a part of a display pixel area of said thin film transistor therewith.

10. A liquid crystal display device including a first substrate on which a thin film transistor is fabricated, a second substrate spaced away from and facing said first substrate, and a liquid crystal layer sandwiched between said first and second substrates, wherein an externally incident light is reflected towards a viewer to display images,
said first substrate including:
(a) an electrically insulating substrate;
(b) a plurality of projections formed on said electrically insulating substrate for scattering reflected light;
(c) a first electrically insulating film covering said projections therewith;
(d) a light-reflecting film formed on said first electrically insulating film;
(e) a second electrically insulating transparent film formed on said light-reflecting film; and
(f) a pixel electrode formed on said second electrically insulating transparent film.

11. The liquid crystal display device as set forth in claim 10, wherein said second electrically insulating transparent film is comprised of an organic film.

12. The liquid crystal display device as set forth in claim 10, wherein said second electrically insulating transparent film is comprised of an inorganic film.

13. The liquid crystal display device as set forth in claim 10, wherein said light-reflecting film covers at least a part of a display pixel area of said thin film transistor therewith.

14. A liquid crystal display device including a first substrate on which a thin film transistor is fabricated, a second substrate spaced away from and facing said first substrate, and a liquid crystal layer sandwiched between said first and second substrates, wherein an externally incident light is reflected towards a viewer to display images,
said first substrate including:
(a) an electrically insulating substrate;
(b) a plurality of projections formed on said electrically insulating substrate for scattering reflected light;
(c) a first electrically insulating film covering said projections therewith;
(d) a light-reflecting film formed on said first electrically insulating film;
(e) a color layer formed on said light-reflecting film; and
(f) a pixel electrode formed on said color layer.

15. The liquid crystal display device as set forth in claim 14, wherein said first substrate further includes a second electrically insulating transparent film formed on said color layer.

16. The liquid crystal display device as set forth in claim 15, wherein said second electrically insulating transparent film is comprised of an organic film.

17. The liquid crystal display device as set forth in claim 15, wherein said second electrically insulating transparent film is comprised of an inorganic film.

18. The liquid crystal display device as set forth in claim 14, wherein said light-reflecting film covers at least a part of a display pixel area of said thin film transistor therewith.
